(19) United States
(12) Patent Application Publication
(10) Pub. No.: US 2025/0332808 A1
(43) Pub. Date: Oct. 30, 2025

(54) Acoustic Attenuation Panel

(71) Applicant: The Boeing Company, Arlington, VA (US)

(72) Inventor: Karthikeyan Dhanapal, Bangalore (IN)

(21) Appl. No.: 18/645,736

(22) Filed: Apr. 25, 2024

(51) Int. Cl. B32B 3/12; B32B 38/18; F02C 7/24

(52) U.S. Cl. CPC B32B 3/12; B32B 38/1841; F02C 7/24; B32B 2305/024; B32B 2305/026; B32B 2307/102; B32B 2605/18; F05D 2260/963

(57) ABSTRACT

An acoustic attenuation panel to reduce noise that emanates from a source, such as an engine of an aircraft. The acoustic attenuation panel includes a porous face layer, a back layer, and an intermediate section positioned between the face layer and the back layer. The intermediate section includes a cellular member with a plurality of cavities, and acoustic metamaterial members positioned in and extending across the cavities.

### TECHNOLOGICAL FIELD

The present disclosure relates generally to the field of noise reduction devices and, more specifically, to noise reduction panels that include acoustic metamaterial members.

### BACKGROUND

Noise regulations limit the allowable noise levels for airports. These regulations limit the impact of aircraft noise on communities that are located near the airports. Various federal and local authorities establish the maximum allowable noise for a given time of the day. Normally, allowable noise levels are higher during the daytime and are reduced during evening and nighttime hours. Some airports have microphones installed around their grounds to monitor the noise levels. Monetary fines or other measures can be taken to enforce the regulations.

Aircraft are designed to reduce the amount of noise during operation. Some aircraft position noise reduction materials within the engines. However, these materials are relatively heavy and add weight to the aircraft thereby reducing the performance and fuel efficiency of the aircraft. Further, these materials are also relatively thick to particularly target higher frequency noise. These thicker materials are often difficult to design to effectively reduce the overall noise and the noise at certain frequencies. Further, the attachment of thicker materials within the engine can encroach on components of the engine. The thick materials can also interfere with the integration of the engine core mounted accessories.

Noise reduction measures are also used in other environments. One example includes a manufacturing facility that includes industrial equipment that produce high noise levels. Noise attenuation devices are used on the equipment and/or in the area surrounding the equipment in an attempt to reduce the noise levels. However, existing noise reduction measures have drawbacks and are not effective in attenuating the noise and/or have additional issues that make their use impractical.

Therefore, there is a need for noise reduction devices that attenuate noise and are able to be effectively designed and manufactured. For aircraft use, the devices should be configured to allow for use with an aircraft engine without interfering with the operation and also be relatively light weight. For other applications, the devices should be configured to be mounted in proximity to the source of the noise.

### SUMMARY

One aspect is directed to an acoustic attenuation panel to reduce noise that emanates from a source. The acoustic attenuation panel comprises a porous face layer, a back layer, and an intermediate section positioned between the face layer and the back layer. The intermediate section comprises a cellular member comprising a plurality of cavities and acoustic metamaterial members positioned in and extending across the cavities. The back layer is configured to be mounted to a surface in proximity to the source.

In another aspect, at least one of the acoustic metamaterial members is positioned in each of the cavities.

In another aspect, the acoustic metamaterial members are positioned within a central section of the cavities and are spaced away from each of the face layer and the back layer.

In another aspect, at least two of the acoustic metamaterial members are positioned in the cavities.

In another aspect, the at least two acoustic metamaterial members in the cavities are spaced apart.

In another aspect, each of the acoustic metamaterial members positioned in the cavities comprise different shapes.

In another aspect, a septum that is porous and extends across the cellular member between the face layer and the back layer and forms an upper section and a lower section of each of the cavities.

In another aspect, the acoustic metamaterial members are positioned in the upper section and the lower section of the cavities.

In another aspect, the acoustic attenuation panel is mounted on an engine nacelle of an aircraft.

In another aspect, the face layer, the back layer, and the intermediate section are flexible to enable the acoustic attenuation panel to be mounted on a curved surface of the aircraft.

In another aspect, the cavities and the acoustic metamaterial members comprise matching polygonal shapes to enable the acoustic metamaterial members to extend across an entirety of the cavities.

In another aspect, the acoustic metamaterial members are constructed from a polymer.

In another aspect, the cellular member comprises a honeycomb structure.

One aspect is directed to an acoustic attenuation panel to reduce noise that emanates from a source. The acoustic attenuation panel comprises a face layer, a back layer, and a cellular member positioned between the face layer and the back layer. The cellular member comprises a first side mounted to the face layer, a second side mounted to the back layer, cavities that extend through the cellular member with open faces at the first side and the second side, and acoustic metamaterial members connected to the cellular member and positioned in the cavities with the acoustic metamaterial members sized to extend across the cavities.

In another aspect, the cellular member comprises a honeycomb structure with the cavities comprising a polygonal sectional shape.

In another aspect, the acoustic metamaterial members comprise a matching sectional shape to the cavities.

In another aspect, the face layer and the back layer are constructed from one of metals and carbon fibers, and the acoustic attenuation panel constructed from a polymer.

One aspect is directed to a method of making an acoustic attenuation panel. The method comprises: positioning a cellular member in an orientation to access a plurality of cavities with the cellular member comprising a honeycomb structure with the plurality of cavities that extend through the cellular member; mounting acoustic metamaterial members in the cavities with outer edges of the acoustic metamaterials contacting against the honeycomb structure; mounting a face layer on a first side of the cellular member with the face layer spaced away from the acoustic metamaterial members; and mounting a back layer on a second side of the cellular member with the back layer spaced away from the acoustic metamaterial members.

In another aspect, the method further comprises mounting additional acoustic metamaterial members in the cavities of the cellular member.

In another aspect, the method further comprises mounting the back layer to a surface of an aircraft.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft.

FIG. 2 is a partial cut-away perspective view of an engine that includes one or more acoustic attenuation panels mounted on the engine nacelle.

FIG. 3 is a schematic diagram of a section of an acoustic attenuation panel.

FIG. 4 is an exploded schematic diagram of the acoustic attenuation panel of FIG. 3.

FIG. 4A is an exploded view of an AMM member having an exactingly-designed structure.

FIG. 5 is a schematic side view of an acoustic metamaterial member positioned within a cavity of a cellular member of an acoustic attenuation panel.

FIG. 6 is a schematic side view of an acoustic metamaterial members positioned within a cavity of a cellular member of an acoustic attenuation panel.

FIG. 7 is a schematic side view of a portion of acoustic attenuation panel having acoustic metamaterial members positioned within cavities of a cellular member.

FIG. 8 is a schematic side view of a portion of acoustic attenuation panel having acoustic metamaterial members positioned within cavities of a cellular member.

FIG. 9 is a flowchart diagram of a method of making an acoustic attenuation panel.

### DETAILED DESCRIPTION

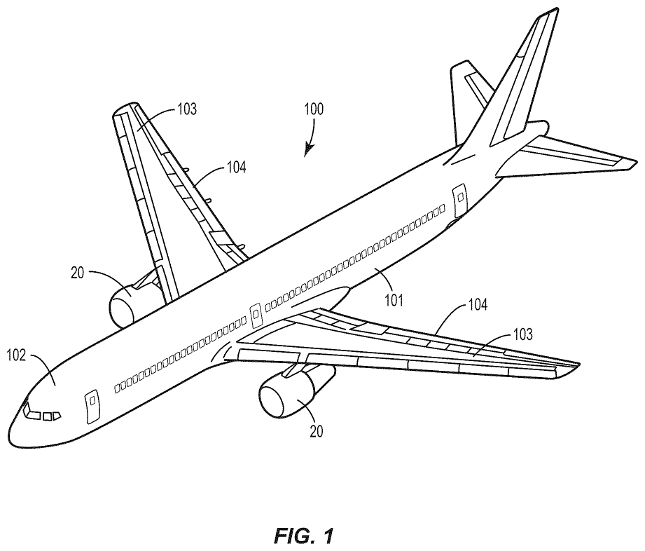

FIG. 1 illustrates an aircraft 100 configured to transport passengers and/or cargo. The aircraft 100 generally includes a fuselage 101 with a flight deck 102 configured to accommodate flight personnel to control the aircraft. Engines 20 are mounted on the wings 103 on opposing sides of the fuselage 101. Flight control members 104 such as flaps are positioned on the wings 103 to control the flight.

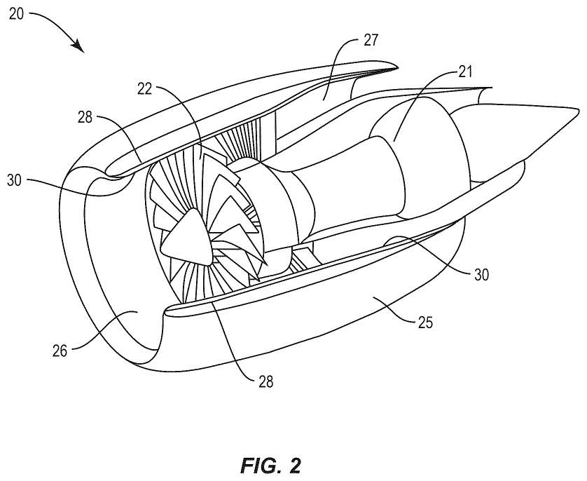

A variety of different engines 20 can power the aircraft 100. Examples include but are not limited to gas turbine engines and turbofan engines. FIG. 2 is a partial cut-away view of the engine 20. The engine 20 includes an engine core 21 and a fan 22. A nacelle 25 extends around the engine core 21 and fan 22. The nacelle 25 includes an inlet 26 that directs the air to the engine core 21 and fan 22. A bypass duct 27 is formed between the engine core 21 and the nacelle 25. A portion of the air that enters the engine 20 at the inlet 26 passes the fan 23 and enters the engine core 21. The remainder of the air enters the bypass duct 27 that extends around the engine core 21.

One or more acoustic attenuation panels 30 are mounted to the inner wall 28 of the nacelle 25 to attenuate the noise produced by the engine 20. The acoustic attenuation panel 30 is positioned at various locations along the inner wall 28, including along one or more of the inlet 26 and the bypass duct 27. In some examples, the acoustic attenuation panel 30 extends completely around the inner wall 28 of the nacelle 25 and has a substantially annular shape. In other examples, the acoustic attenuation panel 30 extends around a limited portion of the inner wall 28 of the nacelle 25. This placement attenuates the radiated noise from one of both of the fan 22 and the engine core 21 (such as the noise caused by the turbine and combustor). In some examples, a single acoustic attenuation panel 30 is mounted to the inner wall 28. In other examples, two or more acoustic attenuation panels 30 are spliced together and mounted to the inner wall 28.

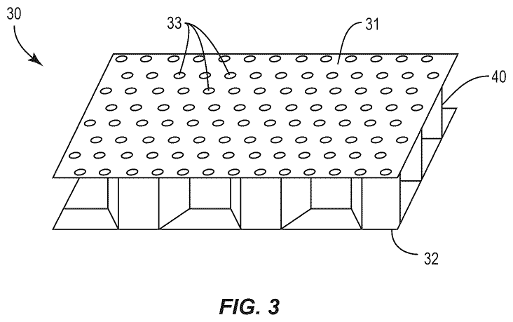

FIG. 3 illustrates the acoustic attenuation panel 30 configured to be attached to the nacelle 25. The acoustic attenuation panel 30 includes different layers that work in combination to perform the noise attenuation. The acoustic attenuation panel 30 includes a porous top referred to as a face layer 31 that faces towards the source. In the context of the engine 20, the face layer 31 faces into the interior of the nacelle 25. An impervious bottom referred to a back layer 32 is configured to be attached to the inner wall 28 of the nacelle 25. An intermediate section 40 is positioned between the face layer 31 and the back layer 32. The intermediate section 40 is constructed from a number of different components arranged in one or more layers.

The face layer 31 is exposed and faces outward into the interior of the nacelle 25 when the acoustic attenuation panel 30 is mounted in the engine 20. The face layer 31 is perforated with openings 33 to enable sound waves to pass through and into the intermediate section 40. The face layer 31 can include different configurations with examples including but not limited to a perforate plate, a wire mesh and a felt-metal. The face layer 31 is constructed from various materials including but not limited to various metals and carbon fiber.

The back layer 32 is a solid member that prevents/reduces the passage of the sound waves and forms the back of the acoustic attenuation panel 30. The back layer 32 includes an outer surface configured to contact against the surface to which it is mounted. The back layer 32 can be constructed from various materials including but not limited to various metals and carbon fiber.

The intermediate section 40 is constructed to reduce noise within a frequency range. During use, the acoustic attenuation panel 30 is mounted with back layer 32 connected to or facing towards a surface, such as the inner wall 28 of an engine nacelle 25 or a panel in proximity to a manufacturing machine. The face layer 31 faces outward towards the source of the noise. The acoustic waves penetrate through the openings 33 of the face layer 31 and pass into the cavities 42. The acoustic energy is dissipated by the visco-thermal effect in the cavities 42.

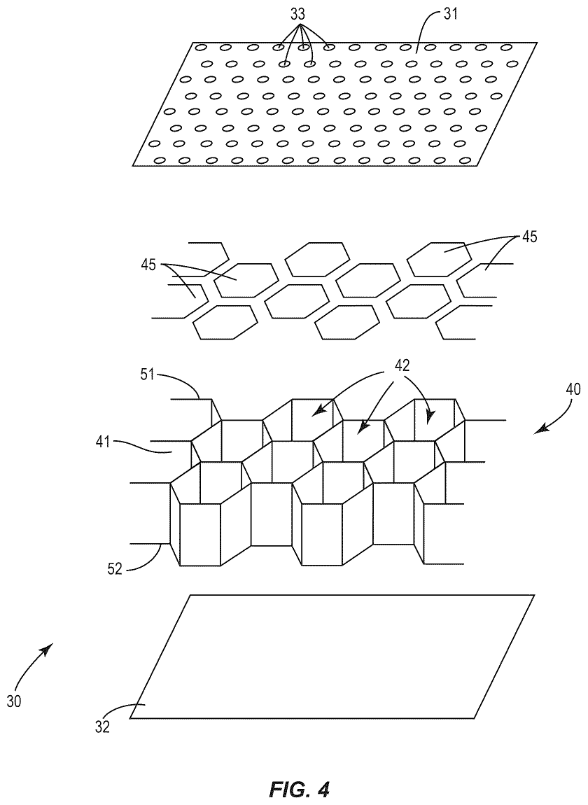

FIG. 4 illustrates a schematic exploded view of the acoustic attenuation panel 30. The acoustic attenuation panel 30 includes the face layer 31 and the back layer 32. The intermediate section 40 includes a cellular member 41 and acoustic metamaterial (AMM) members 45. The AMM members 45 are sized to fit within cavities 42 of the cellular member 41. In some examples, the AMM members 45 are positioned in each of the cavities 42 of the cellular member 41. In other examples, the AMM members 45 are positioned in a limited number of cavities 42. In one example, the AMM members 45 are evenly distributed around the cellular member 41 with empty cavities 42 also evenly distributed around the cellular member 41. In some examples, the number of AMM members 45 and the number of empty cavities 42 is the same. In other examples, the number of AMM members 45 and empty cavities 42 is different.

The cellular member 41 includes a top side 51 and a bottom side 52. The top side 51 is mounted to the face layer 31 and the bottom side 52 is mounted to the back layer 32. The thickness of the cellular member 41 measured between the top side 51 and the bottom side 52 can vary. Cavities 42 extend through the cellular member 41 and are open at both the top side 51 and the bottom side 52.

In some examples as illustrated in FIG. 4, the cellular member 41 has a honeycomb structure with the cavities 42 having polygonal sectional shapes. In other examples, the cavities 42 include different shapes such as but not limited to oval, circular, and irregular shapes. The cavities 42 throughout the cellular member 41 can have the same or different shapes and sizes. The shape and size of the cellular member 41 is designed to address one or more frequency bands of the noise. The cellular member 41 can be constructed from a variety of materials, including but not limited to aluminum and glass fiber.

The AMM members 45 are man-made materials designed to control, direct, and manipulate the sound waves that enter into the intermediate section 40. In some examples, the AMM members 45 are scaled to be smaller than the wavelength. AMM members 45 can be constructed from material including but not limited to polymers such as thermoplastic polyurethane (TPU). The AMM members 45 are included in the cavities 42 to control the sound waves through manipulating parameters such as the bulk modulus & density.

FIG. 4A illustrates an example of an AMM member 45. The AMM members 45 gain their properties from their exactingly designed structures. These structures include but are not limited to the precise shape, geometry, size, orientation, and arrangement of the nanostructures.

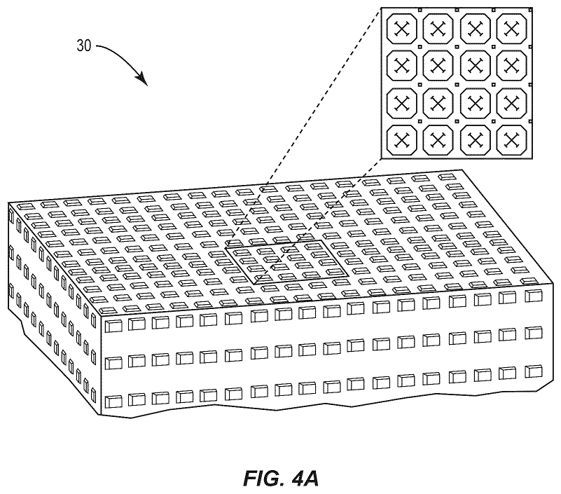

FIG. 5 illustrates a section of an acoustic attenuation panel 30. A cellular member 41 is positioned between a face layer 31 and a back layer 32. An AMM member 45 is positioned within a cavity 42 of the cellular member 41. In this example, the AMM member 45 includes a top section 46 and legs 47. The top section 46 is shaped and sized to extend across the entirety of the cavity 42. In some examples, the outer edges of the top section 46 are attached to the walls of the cavity 42. The legs 47 extend outward from the top section 46 and are secured to the walls of the cavity 42. The AMM member 45 is positioned at a depth in the cavity 42 away from both the face layer 31 and the back layer 32. In some examples, all of the other cavities 42 in the acoustic attenuation panel 30 include a similar construction with an AMM member 45. In other examples, one or more of the cavities 42 is empty or include different and/or additional AMM members 45. In some examples, the AMM member 45 contacts against one or both of the face layer 31 and back layer 32.

Throughout the cellular member 41, the AMM members 45 can be positioned at the same or different depths within the cavities 42. In some examples, all of the other cavities 42 in the acoustic attenuation panel 30 include a similar construction of AMM members 45. In other examples, one or more of the cavities 42 is empty or include different and/or additional AMM members 45.

The AMM members 45 are sized to extend across the cavity 42. In some examples, the cavities 42 and the AMM members 45 include the same sectional shape and size. This enables the AMM members 45 to extend across and contact against the walls of the cavities 42. In one specific example, each of the cavities 42 and the AMM members 45 include polygonal sectional shapes.

The AMM members 45 can be mounted to the cellular member 41 in various manners. In some examples, the AMM members 45 and cellular member 41 are constructed in the same process and formed together, such as in an additive manufacturing process. In some examples, the intermediate section 40 is constructed with a 3D printing technology in which a honeycomb cellular member 41 and AMM members 45 are created simultaneously using two distinct nozzles and two different materials. Additionally or alternatively, the AMM members 45 are mounted with adhesives in the cavities 42.

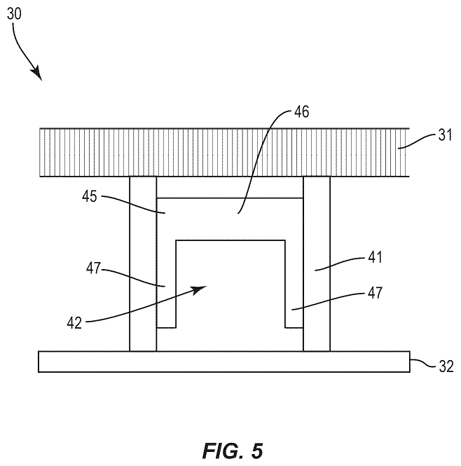

In some examples two or more AMM members 45 are positioned within a cavity 42. FIG. 6 illustrates an example with a pair of AMM Members 45a, 45b mounted in the cavity 42. The AMM members 45a, 45b are spaced apart in the cavity 42 by a gap. Further, each of the two AMM members 45a, 45b are positioned away from the face layer 31 and the back layer 32. The AMM members 45 can include the same or different shapes and can be constructed from the same or different materials.

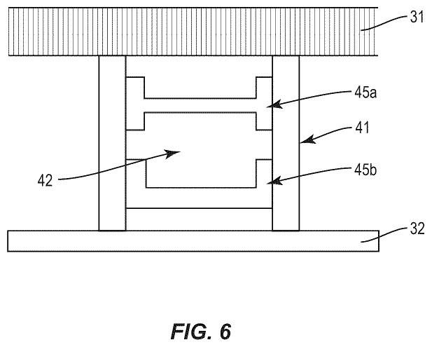

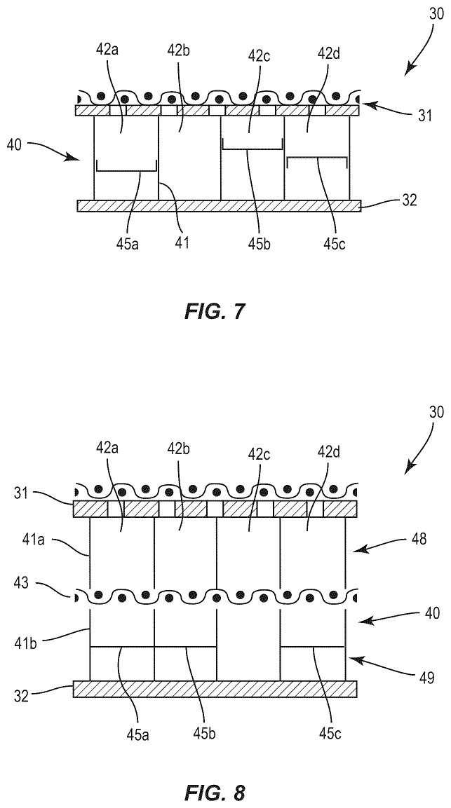

In some examples as illustrated in FIG. 7, the acoustic attenuation panel 30 has a single degree of freedom (SDOF) that includes face layer 31, back layer 32, and intermediate cellular member 41. The cavities 42 are continuous between the face layer 31 and the back layer 32. In other examples as illustrated in FIG. 8, the acoustic attenuation panel 30 has a double degree of freedom (DDOF) in which the cavities 42 are divided by a porous septum 43. In the example of FIG. 8, the intermediate section 40 includes a first honeycomb layer 41a, a porous septum 43, and a second honeycomb layer 41b. An upper section 48 is formed between the face layer 31 and the septum 43, and a lower section 49 is formed between the septum 43 and back layer 32. AMM members 45 are positioned in one or both of the upper section 48 and lower section 49. The septum 43 is porous having openings to allow the sound waves to travel from the upper section 48 to the lower section 49. The septum 43 can be constructed from a variety of different materials, including but not limited to a perforate plate, a wire mesh and a felt-metal.

The acoustic attenuation panel 30 functions as a Helmholtz resonator. A SDOF design forms a single resonator. A DDOF design couples two Helmholtz resonators in series.

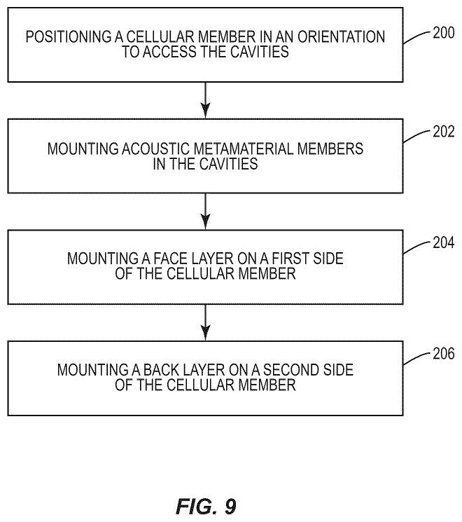

FIG. 9 illustrates a flowchart of a method of making an acoustic attenuation panel 30. A cellular member 41 is positioned for processing (block 200). The cellular member 41 includes a honeycomb structure with through-extending cavities 42. AMM members 45 are mounted in the cavities 42 (block 202). Outer edges of the AMM members 45 contact against the honeycomb structure. A face layer 31 is mounted on a first side of the cellular member 41 (block 204). The face layer 31 is spaced away from the AMM members 45. A back layer 32 is mounted on a second side of the cellular member 41 (block 206). The back layer 32 spaced away from the AMM members 45.

The order of the various steps of making the acoustic attenuation panel 30 can vary. In some examples, the AMM members 45 are mounted to the cellular member 41 prior to mounting to either of the face layer 31 and the back layer 32. In other examples, the cellular member 41 is mounted to one of the face layer 31 and the back layer 32 prior to mounting the AMM members 45 in the cavities 42.

The acoustic attenuation panel 30 can include various thicknesses measured between the face layer 31 and the back layer 32. Examples include but are not limited to thicknesses ranging between 1-3 inches.

The intermediate section 40 of the acoustic attenuation panel 30 is configured to be mounted to a variety of surfaces. In some examples, the acoustic attenuation panel 30 is flexible to enable mounting to flat surfaces as well as curved surfaces. In other examples, the acoustic attenuation panel 30 is rigid.

The acoustic attenuation panel 30 can be used to attenuate noise in a variety of different environments. In some examples, the acoustic attenuation panel 30 is mounted to the inner wall 28 of an engine nacelle 25 of an aircraft 100. In a specific example, the acoustic attenuation panel 30 is mounted to one or more of the inlet 26 and bypass duct 27. Other mounting positions on an aircraft 100 include but are not limited to the internal ducts of the engine 20, the trailing and side edges of the wings 103, and along one or more of the flight control members 104.

In another example, the acoustic attenuation panel 30 is mounted to other vehicles, such as but not limited to cars, trucks, boats, spacecraft, rockets, and drones.

In another example, the acoustic attenuation panel 30 is mounted within a manufacturing facility in proximity to a source of the noise. In some examples, the acoustic attenuation panel 30 is mounted to the interior or exterior of a machine that produces the noise. In some examples, the acoustic attenuation panel 30 is mounted to walls in the vicinity of the machine.

In some examples, the acoustic attenuation panel 30 is a single member shaped and sized to extend across the surface. In other examples, the acoustic attenuation panel 30 is constructed from two or more sections. The sections are abutted together and connected such as through adhesives and mechanical fasteners. In some examples, the different sections are spliced together. In one example in which the acoustic attenuation panel 30 is mounted within the engine nacelle 25 which has a cylindrical shape, different members are structurally joined together at a spline to form an overall annular shape that extends around the engine core 21 and fan 22.

The acoustic attenuation panel 30 provides for attenuating noise in a variety of different environments. The acoustic attenuation panel 30 is relatively light weight and thin to facilitate mounting at different locations. Further, the acoustic attenuation panel 30 is constructed in a manner to provide for quality noise attenuation. In one example in which the acoustic attenuation panel 30 is used on an aircraft 100, the panel achieves superior acoustical performance, including dramatic noise reduction during take-off and landing, with a relatively small increase in weight.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. An acoustic attenuation panel to reduce noise that emanates from a source, the acoustic attenuation panel comprising:
a porous face layer;
a back layer;
an intermediate section positioned between the face layer and the back layer, the intermediate section comprising:
a cellular member comprising a plurality of cavities;
acoustic metamaterial members positioned in and extending across the cavities; and
wherein the back layer is configured to be mounted to a surface in proximity to the source.

2. The acoustic attenuation panel of claim 1, wherein at least one of the acoustic metamaterial members is positioned in each of the cavities.

3. The acoustic attenuation panel of claim 1, wherein the acoustic metamaterial members are positioned within a central section of the cavities and are spaced away from each of the face layer and the back layer.

4. The acoustic attenuation panel of claim 1, further comprising at least two of the acoustic metamaterial members positioned in the cavities.

5. The acoustic attenuation panel of claim 4, wherein the at least two acoustic metamaterial members in the cavities are spaced apart.

6. The acoustic attenuation panel of claim 4, wherein each of the acoustic metamaterial members positioned in the cavities comprise different shapes.

7. The acoustic attenuation panel of claim 1, further comprising a septum that is porous and that extends across the cellular member between the face layer and the back layer and forms an upper section and a lower section of each of the cavities.

8. The acoustic attenuation panel of claim 7, wherein the acoustic metamaterial members are positioned in the upper section and the lower section of the cavities.

9. The acoustic attenuation panel of claim 1, wherein the acoustic attenuation panel is mounted on an engine nacelle of an aircraft.

10. The acoustic attenuation panel of claim 9, wherein the face layer, the back layer, and the intermediate section are flexible to enable the acoustic attenuation panel to be mounted on a curved surface of the aircraft.

11. The acoustic attenuation panel of claim 1, wherein the cavities and the acoustic metamaterial members comprise matching polygonal shapes to enable the acoustic metamaterial members to extend across an entirety of the cavities.

12. The acoustic attenuation panel of claim 1, wherein the acoustic metamaterial members are constructed from a polymer.

13. The acoustic attenuation panel of claim 1, wherein the cellular member comprises a honeycomb structure.

14. An acoustic attenuation panel to reduce noise that emanates from a source, the acoustic attenuation panel comprising:
a face layer;
a back layer;
a cellular member positioned between the face layer and the back layer, the cellular member comprising:
a first side mounted to the face layer;
a second side mounted to the back layer;
cavities that extend through the cellular member with open faces at the first side and the second side; and
acoustic metamaterial members connected to the cellular member and positioned in the cavities, the acoustic metamaterial members sized to extend across the cavities.

15. The acoustic attenuation panel of claim 14, wherein the cellular member comprises a honeycomb structure with the cavities comprising a polygonal sectional shape.

16. The acoustic attenuation panel of claim 15, wherein the acoustic metamaterial members comprise a matching sectional shape to the cavities.

17. The acoustic attenuation panel of claim 15, further comprising:
the face layer and the back layer constructed from one of metals and carbon fibers; and
the acoustic attenuation panel constructed from a polymer.

18. A method of making an acoustic attenuation panel, the method comprising:
positioning a cellular member in an orientation to access a plurality of cavities, the cellular member comprises a honeycomb structure with the plurality of cavities that extend through the cellular member;
mounting acoustic metamaterial members in the cavities with outer edges of the acoustic metamaterials contacting against the honeycomb structure;
mounting a face layer on a first side of the cellular member with the face layer spaced away from the acoustic metamaterial members; and
mounting a back layer on a second side of the cellular member with the back layer spaced away from the acoustic metamaterial members.

19. The method of claim 18, further comprising mounting additional acoustic metamaterial members in the cavities of the cellular member.

20. The method of claim 18, further comprising mounting the back layer to a surface of an aircraft.
